(19) United States
(12) Patent Application Publication
(10) Pub. No.: US 2013/0266705 A1
(43) Pub. Date: Oct. 10, 2013

(54) METHOD, DEVICE, AND SYSTEM FOR PRESERVING OF NUTRITIONAL VALUE AT FOOD MATERIALS IN A COURSE

(71) Applicant: Carolina Sundberg, Vendelso (SE)

(72) Inventor: Carolina Sundberg, Vendelso (SE)

(21) Appl. No.: 13/993,347

(22) PCT Filed: Dec. 21, 2011
(86) PCT No.: PCT/SE11/00238

§ 371 Date: Jun. 12, 2013

(30) Foreign Application Priority Data
Dec. 31, 2010 (SE) 1001211-0
Jul. 6, 2011 (SE) 110525-3

(51) Int. Cl. A23L 3/10; A23L 3/36

(52) U.S. Cl. CPC A23L 3/10; A23L 3/36
USPC 426/394; 62/440; 62/441; 165/104.17

(57) ABSTRACT

The present invention relates to a method, means and packaging system to preserve nutritious values of food included in a food dish. The invention is characterized in that the food ingredients are placed in a tempered storing container forming part of a storing system including a container (A) with a lid part (B), whereby the lid part has a chamber (C) for receiving of a phase exchangeable medium, and which chamber (C) is restricted of an inner covering part (E) which is sealed and attached to the lid part (B) by a joining means (F) at the same time forming a seal between the storing container and lid part, that the phase exchangeable medium is cools/heated during a phase exchange to a solid/liquid state and is placed on the storing container to cool/keeping warm/heating the food.

The present invention relates to a method, means and packaging system to preserve nutritious values of food included in a food dish, more precisely to a method for tempering food products and a storing system including a temperature preserving container to perform said method.

Cool storing is a highly conventional way to prolong the usage of food. Normal and fresh raw substances for cocking food are subjected to a natural decomposition process, which at a certain stage makes the raw material and the processed food not usable as food for human beings. The humans do not have the intestinal flora needed to take care of food extremely contaminated by bacteria.

In these modern times there is a growing need to have a real control of the content in the food being consumed. Food engineers and chemists may have go a too dominating role together with short term economists in the decision to bring forward and put to market easy going food dishes of cheap and sometimes bad raw material. Long lasting durability is seldom achieved by life restricting preservatives and the sweetness in sugar free products and raw materials is often pure chemical. The actual consequences of this ought to be that we in a greater extent will cook our own food including a careful choice of ingredients combined with an increasing knowledge and recognition of said ingredients. This processing will to a great extent be valid to food in schools and hospitals that is food for growing generation being educated and to them being treated at hospitals. Prior to the consequences of the short term thinking in the process of purchasing food for schools has been understood by our elected politicians and the responsible experts to have them perform commendable decisions it will in a foreseeable time rest upon us consumers to take back control over the quality of the food.

Raw material and its way from seed, farmer, and intermediaries to the stores and from there to our kitchen/dinner tables are often long and above all expensive. This means that neighbour grown, kitchen gardens, art of cooking and mistress properties will once more come into its own. The present invention will then be of assistance for a continued controlled part in the distribution/handling in the last link in the food processing chain, which is from the kitchen to the consuming.

The main object of the present invention is to achieve an effective temperature preservation and especially a prolonging of the temperature influenced negative process acting on food and food dishes being stored in special easy transportable containers, in which there also is the possibility to heat up and to keep warm. Besides of keeping the nutritious values it is also of no less importance that the food is kept at a right temperature and being appetizing when served and thus will offer great taste experiences.

Another object is to obtain a container for storing and temperature preservation of food and food dishes in which a lid device will give the possibility to cool and keep cool or to heat and keep warm.

Yet another object is to obtain a storing container in the size of 0.3 to 2.4 litres with a built in capacity to keep content cool, preferably a vegetable based food dish, up to 7 hours.

Yet another object of the invention is to obtain a technique where the cooling is obtained both by built in cooling medium containing apartments in containers/lids and by insert of temperature preserving arrangements in direct or close contact to a food dish.

Still another object of the invention is to obtain a technique where e.g. the cooling medium in the container and/or lid will change colour when exceeding a temperature signalling danger to the health of an unfit content.

Still another object of the present invention is to disclose a packaging system with a cooling capacity, especially for fish dishes (type sushi) where different grades of a cooling effect may be achieved for different type of ingredients in the dish.

Yet another object of the present invention is to obtain a packaging system with separate loose trays or departments for different types of food ingredients such as sauces, salads, meat, vegetables, etc. It is also possible to arrange different spaces for cutleries, that is will have different configurations to fit cutleries and tools respectively. The different spaces or departments in the token portion may cooperate with especially designed and cooling lid portions.

Still another object of the invention is to obtain a packaging system with different types of lids, one lid to keep cool and another lid for heating the whole or certain parts of the ingredients forming part of a dish. A phase exchangeable material for the lid well suited for heating is stearine or wax, or a mixture of these. The combination or material chosen is the one suited for the method of heating and which performs the temperature suited for the current dishes. One should thereby avoid phase changeable materials causing a volume increase in the phase from liquid to gas, but it is in the transmission between solid and liquid as the heat accumulation and the later release of heat shall take place and vice versa. In this connection may be mentioned a special lid being open able on the topside that is it is possible to take out or put back cooling or heating modules in the lid depending on the need. This will bring special practical advantages, as a dish made in the evening may be stored in the main department in the fridge with the lid and without cooling module, which is placed in the freezer. The lid works to a full extent to cover and seal the main department. It is first when the main department is brought out from the fridge as it is equipped with the“charged” cooling module. When the food in the main department shall be consumed it can be fitted with a certain heating module in the lid if it is a dish best suited to be eaten warm. This special lid being opened able from above may be completely removable and have a special form or colour for the current dish. There is an option to integrate this with the cooling or heating module.

A last object of the present invention is to disclose a storing system where the present container and lid portions have different grades of cooling/heating and/or insulation properties to regulate and control the heat exchange with the dishes in an optimum way.

The objects mentioned above will be achieved by the method for preserving nutritious values in a food dish and the package system to temperature preserving food having the characterizing clauses mentioned in the claims.

In connection to heating before ingestion and using a micro oven without jeopardizing the existing nutritious values in the current dish it is possible to just expose the lid containing the phase changeable cooling medium to the micro waves to make the accumulated heat being transferred to the food in an essentially more healthy way.

The method to keeping the food substances cool will according to the present invention require a temperature holding storing container with a built in cooling capacity, preferably in a lid portion. This is per se previously known. Thus the lid parts at known containers have often become inflexible and hard to handle at the opening and closing. This is caused by keeping a cooling medium making the plastic material inflexible and hard to handle during opening and closing when temperatures are low. Furthermore the cooling capacity of known containers has been too week to fulfill the tempering purpose essentially longer than 2-3 hours.

The invention will be described below in connection to embodiments, where

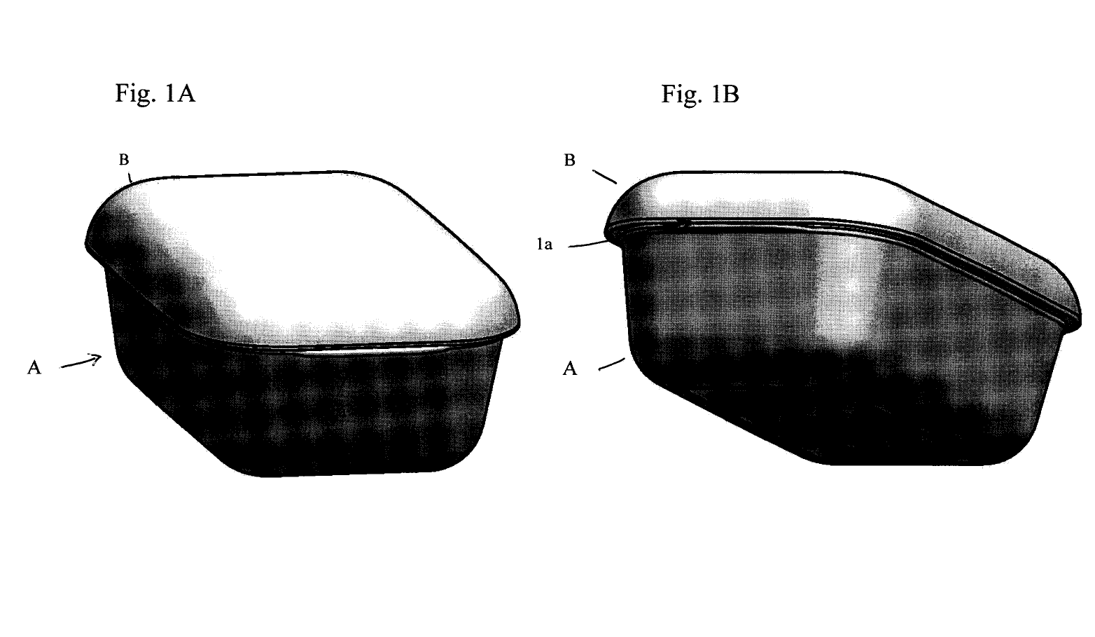

FIG. 1A is a diagrammatic view from above of a storing container having a losable lid,

FIG. 1B shows the container according to FIG. 1A in a diagrammatic view from below,

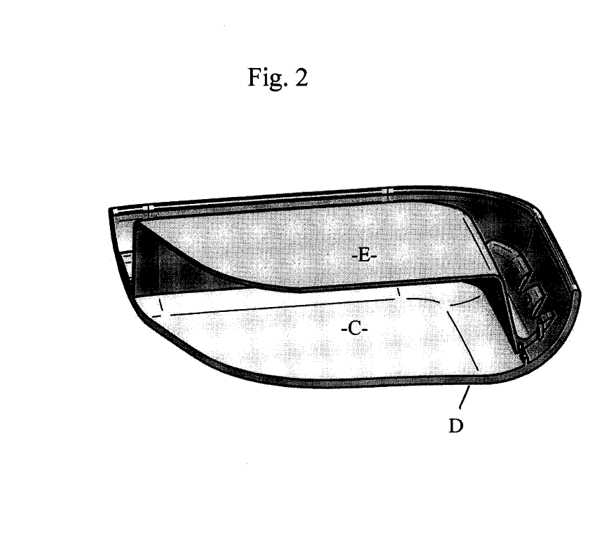

FIG. 2 is a diagrammatic view from above of a cut out partial view of an outer lid part having an inner covering part forming the cool medium receiving space in the lid,

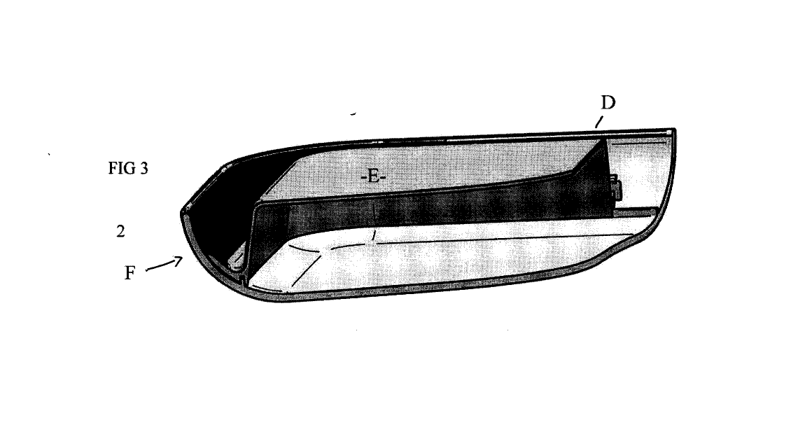

FIG. 3 is a diagrammatic view from above of the other side of the cut out partial view according to FIG. 2 and with an encased joint strip,

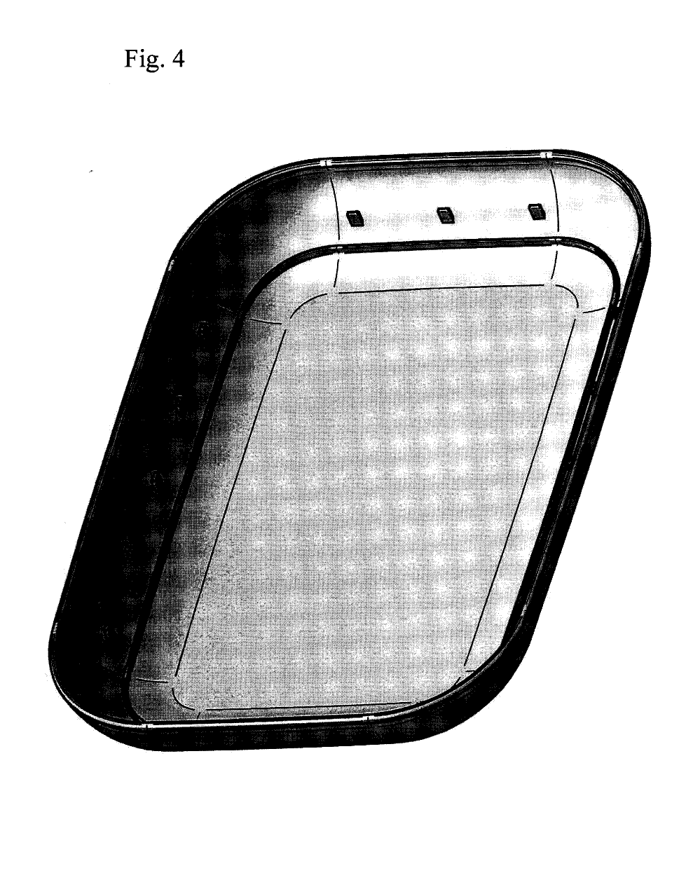

FIG. 4 is a diagrammatic view of the outer lid part without an inner covering part,

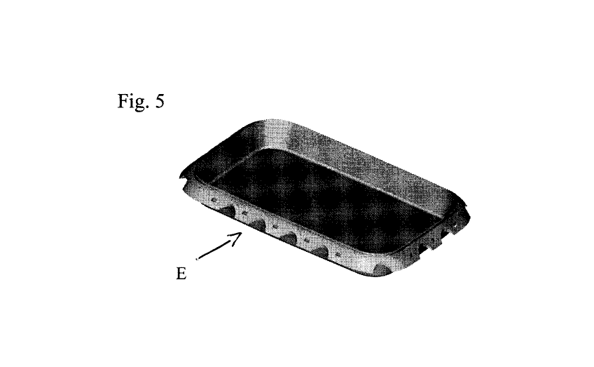

FIG. 5 is a diagrammatic view of the covering part cooperating with the lid part according to FIG. 4, and where

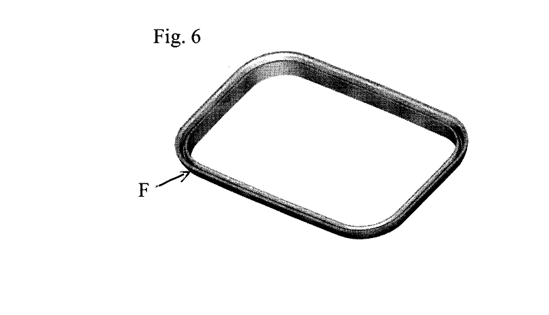

FIG. 6 is a diagrammatic view of the joint strip also having the purpose to join the outer lid part and the inner lid part.

FIG. 1A and FIG. 1B disclose the storing container A having a removable lid B and built in cooling capacity. The lid B, see also FIGS. 2 and 3, has a sealed department C containing the cooling medium. This department C is shown in FIG. 2. The cooling medium may be a liquid or a cooling gel being transferred into a solid state (phase exchange) at a constant lower temperature and which keeps this lower temperature during the phase exchange going on to and from a liquid state during a simultaneous taking up or giving away of heat.

FIGS. 2 and 3 disclose that the lid B itself constitutes of an outer lid part D and an inner covering part E forming the space C between themselves for the cooling medium acting to keep the temperature of the contents of the storing container when the lid part is sealed and applied to the container A. There are points of orienting or lugs in the lid part D acting as support to the inner covering part prior to this being completely sealed by a fixing sealing arrangement containing joint strip (FIG. 3).

The lid part D is shown completely in FIG. 4. The thickness of the wall of said inner covering part E is preferably less than the outer wall thickness of the outer lid part D. The inner covering part E is shown completely in FIG. 5, where a disclosing of the wall portion of the inner covering part E is undulated. These because increasing the active effective joint line between the lid part D and the covering part E. The peripheral edge has also recesses into which the lugs are fitted and grip and hold the lid part D in a correct position during the final mounting and fixing by said joint arrangement containing joint strip F. This fixing is necessary from several reasons. On one hand a correct relative position between the lid part D and the covering part E shall be assured prior to the fixing phase when the joint strip F is applied, and on another hand must the forces coming from a volume change of the cooling medium during a phase transformation be handled without having the sealing properties between the lid part D and the covering part E endangered. In the joint strip F there is also the sealing arrangement G between the container A and the lid part. The joint strip is injection moulded in place using a thermoplastic polymer, which in a heated liquid state will form a molecular bonding between the lid part and the covering part. Because of this the lid part and the covering part must be placed in a certain moulding tool where the material of the joint strip is injected in a heated liquid state.

In FIG. 3 is shown the left portion of the lid part D shown in FIG. 2 with the inner covering part E. In addition to what is shown in FIG. 2 here can also be seen the sealing arrangements containing joint strip F.

The joint strip F is fully shown in FIG. 6 where also the sealing arrangement G can be seen along its entire periphery. Preferably the joint strip is injection moulded in place in a plastic forming tool after the lid part and the inner covering part have been placed in correct relative positions. Thus the joint strip F has a double function by both seal, lock and permanently connect the lid part D and the covering part E and at the same time being shaped as a sealing arrangement G towards the container A. The joint strip F consists of a material having good elastic properties also at low temperatures that is so it shall not make the lid hard to manage. A thermoplastic elastomer is preferred having a hardness between 45 and 75 Shore A, preferably ca 60 Shore A. Hereby the notch 3 existing in the joint strip F to securely and smoothly be able to cooperate and seal with the groove or spring part (the upper peripheral edge portion) at the container A. By the inner covering part having a material thickness being less than the thickness of the lid the cooling action will be directed more inwards to the container and what is stored there.

How much of the useful volume which shall be received of the temperature controlling lid part D has to be decided from case to case. Of course a bigger cooling capacity will demand a greater volume part of the container A and if it at the same time have different compartments for receiving different kinds of foods with different cooling needs, the total usable storing volume of the container be increased by having the cooling action where it is mostly needed that is where it have its best effect.

The protruding part 1a at the upper edge opening of the container A is one example of a grip friendly arrangement making a controlled manual opening and closing of the container A by acting as an anvil when removing the lid B.

The lid B has a special sealed department E in which a cold medium is received. This refrigerant may be a liquid or a cooling gel being frozen during a phase exchange and which after that can deliver cooling (absorb heat) during keeping of a healthy storing temperature. Advantageously the lid B has certain shaped gripping portions (not shown) facilitating a removal from the container part A. Preferably the phase exchangeable refrigerant is chosen so that it during a relatively long time will deliver cooling at a desired temperature. The choice of refrigerant and shaping of refrigerant containing departments E in the lid B will take place depending upon a specific type of dish/raw material. Thus depending upon the dish a refrigerant keeping a considerably lower temperature can be used also having a capacity (risk) of an instantaneous freezing the stored dish and in that way perform a two-stage effect in the cool storing. A condition for this is that the dish will not decrease quality in taste and consistence by being frozen. The advantage is that the storing time can be essentially extended and/or withstand higher outer temperatures with a retained effect.

Water is the most common substance being phase changed during receiving and delivering of energy. Humid air can per volume unit take up more energy in comparison with dry air and the water in the air is then acting as a phase changeable refrigerant in the same way as in weather systems during transfer of energy and balancing of temperatures by condensing and evaporation of water. The heat from the sun will perform the vaporizing of water. Water will expand when freezing too solid and is by this reason not optimally advantageous to use a refrigerant in connection to the present invention. There are refrigerants on the market being more suitable and which in a high degree will keep an original volume during the phase exchange. Some of these refrigerants will not completely be transferred into a solid phase but exist in a half floating, gel like cool condition. If wanted there is a possibility to add colour-shifting properties at different temperatures of the refrigerant to make sure that a certain stored food is kept at or below a certain temperature. This in turn will require that at least a part of the lid is transparent to a colour shifting.

Regarding shape, volume, colour, cooling and/or heating modules and colour combinations there are many possibilities to create a personal food box being optimally adapted to the current dish.

The present invention can very well be adapted for storing and transportation of temperature sensible raw materials from a store/place of purchase and may then be a part in a pledge system. Thus it is possible to have more of elongated containers for fresh fish or for other raw materials with a specific shape.

The cooling ability of the lid part may also be directed down towards the bottom of the container A. A cylindrical or ring shaped portion of the lid part may contain the refrigerant and in that way expose stored food to cooling or heating. Thus it shall be noted that the preservation of temperature also may mean keeping warm of food at a suitable eating temperature as a dish often is best in taste within pretty close temperature intervals. Even if it is possible to have the one and same refrigerant in the lid for keeping cool and for heating a special lid for keeping warm is preferred as a phase change temperature from liquid to solid being within the above mentioned close temperature intervals and which will guarantee an optimal taste experience of a premade (home cooked) dish being eaten warm. Thus a certain refrigerant for keeping warm gives a much longer warming time as the phase exchange process will release 10 times or more energy.

The invention is not restricted to the above-described embodiments, but modifications can be made within the scope of the following claims.

1-10. (canceled)

11. A method to preserve nutritious values of food included in a food dish comprising:
placing food ingredients in a tempered storing container forming part of a storing system including a container with a lid part, wherein the lid part has a chamber for receiving of a phase exchangeable medium, and the chamber is restricted of an inner covering part which is sealed and attached to the lid part by a joining means at the same time forming a seal between the storing container and lid part, that the phase exchangeable medium is cooled or heated during a phase exchange to a solid liquid state and is placed on the storing container to cool, keep warm, or heat the food.

12. A storing system to preserve nutritious values of food included in a food dish and to perform the method according to claim 10, comprising a tempered storing container with a lid part having a chamber for receiving a phase exchangeable medium and which chamber is restricted by an inner covering part being sealed and attached to the lid part by a joint means at the same time forming a seal between the storing container and the lid part, that the phase interchangeable medium is cooled or heated during a phase exchange to solid or liquid state and is placed on the storing container to cool, keep warm or heat the food.

13. The system according to claim 12, wherein the refrigerant in the chamber of the storing container is a phase exchangeable medium changing colour at the phase exchange, wherein the colour will indicate existing temperature.

14. The storing container forming part of a system according to claim 12 and to perform the method according to claim 10, comprising a lid part, a chamber to receive a phase exchangeable medium, an inner covering part being sealed and attached to the lid part by a joint means forming a seal between the storing container and the lid part.

15. The container according to claim 14, wherein the container is divided in different departments.

16. The container according to claim 15, wherein the departments are created by loose inserts.

17. The container according to claim 16, wherein the inserts are adapted to suit special food dishes.

18. The container according to claim 14, wherein the upper side of the lid part is rigidly connected with the phase exchangeable medium and removable arranged together with said upper side of the lid part.

19. The container according to claim 14, wherein orienting points and/or tags are arranged at the lid part and at the covering part.

20. The container according to claim 19, wherein the joint means is relative fixing the lid part and the inner covering part.
